(19) United States
(12) Patent Application Publication
(10) Pub. No.: US 2013/0332213 A1
(43) Pub. Date: Dec. 12, 2013

(54) Virtual Outsourcing Agency System and Method

(71) Applicant: Jayne Heggen, Tiburon, CA (US)

(72) Inventor: Jayne Heggen, Tiburon, CA (US)

(21) Appl. No.: 13/912,864

(22) Filed: Jun. 7, 2013

Related U.S. Application Data
(60) Provisional application No. 61/656,772, filed on Jun. 7, 2012.

(51) Int. Cl. G06Q 10/06

(52) U.S. Cl. CPC G06Q 10/06313
USPC 705/7.15; 705/7.17

(57) ABSTRACT

A system and method for assembling a virtual agency. In one embodiment, the agency is an advertising agency. Based on a client's needs and requirements, a virtual team is assembled to meet the project needs.

### PRIORITY

This application claims priority to U.S. Ser. No. 61/656,772 filed Jun. 7, 2012, the contents of which are fully incorporated herein by reference.

### FIELD OF THE INVENTION

The present invention relates generally to human resources staffing, and more particularly, to a lean, efficient virtual outsourcing agency system and staffing methodology.

### BACKGROUND

The rise of the internet has led to different types of marketing, which has in turn led to different types of agencies. The economy has led to downsizing at many traditional agencies, and technology has significantly changed the way everyone functions including how creative groups produce their work.

As the marketing and communications industry undertakes digital transformations, they have to rethink what clients value most and create operating and business models that take advantage of what's possible through multiple digital platforms.

In light of this technological explosion of new digital platforms available to reach consumers today with marketing communications, no single agency is an expert on every consumer marketing discipline and importantly, no client wants to work with one agency for social media, another for graphic arts, another for branding strategies, and still others for website development, analytics, and media planning and buying.

Increased customer expectations in the age of more personalization are having a dramatic impact on how companies set strategy and manage their organizations. With the backdrop of existing traditional products, new requirements across multiple platforms, improved interactivity and personalization of content, and along with increasing complexity, the need for fluidity in agency operating models has never been greater.

The virtual outsourcing agency is based upon internal organization user flows that provide a new operating model, driven by a digital technology (internet-tools and apps) platform that customizes teams/talent around specific client engagements, generating the ultimate in collaborative, creative work.

The virtual outsourcing agency's collaborative Talent Network provides a broad range of skills and expertise without needing to have all services “in-house”.

The virtual outsourcing agency will service clients more effectively, manage client engagements profitability and draw from an extensive Talent Network to customize skill sets more effectively, without the financial overhead and physical encumbrances inherent within the current agency work structure. As a result, the virtual outsourcing agency becomes a very desirable alternative to the cumbersome, inefficient operations of traditional agency staffing and operating models.

### SUMMARY

It is an object of this invention to provide a method for creating a virtual agency comprising receiving a client engagement request; generating a virtual team configuration based on the client engagement request, identifying eligible team members from a team member database; selecting plurality of virtual team members from the eligible team members; and issuing a team request for each of the plurality of virtual team members.

Embodiments of the present invention provide a system and method for assembling a virtual agency. In one embodiment, the agency is an advertising agency. Based on a client's needs and requirements, a customized virtual team is assembled to complete a specific task. Embodiments of the present invention provide an aggregation functionality to collect an extensive Talent Network of the best independent talent and creative thinkers in the business to build a virtual team relevant to the client engagement.

Embodiments of the present invention provide independent senior marketing, branding and creative professionals with the relationships, resources and support systems they need to thrive and create a unique interconnected Talent Network exclusively focused on empowering creativity and innovation.

Embodiments of the present invention also provide a common marketplace (community) where interaction among members will occur, and further provide support services that enhance collaboration across the Talent Network. This may be accomplished, in part, by aggregating the talent of many “creative thinkers” (which may be independent specialists/consultants, and/or senior-level executives who have created boutique-like agencies). Creative thinkers are creative technologists (subject matter experts) with specific areas of expertise, who know how the marketing and communications technology works, understand client needs and can collaborate with the right set of people to successfully complete the assigned task. Embodiments of the present invention provides an organization referred to as the Talent Network which provides an operating universe that encourages both independence and interaction, where creative thinkers come together (join) to bid on engagements and other support service

Embodiments of the present invention provide engagements and projects. An engagement is an agreement that the virtual outsourcing agency facilitates between talent and client. This is the primary unit of transaction. Engagements may be comprised of more than a single project. A project is a turnkey multi and single channel programs/campaigns that results from the agreed-upon engagement that is managed by either a client or a certified aggregator. There can also be multiple engagements within a larger project.

There can also be engagements where the project and the engagement is one in the same. In this instance the engagement specifications and cost become a project scope.

Embodiments of the present invention comprise five core competencies: 1) the most comprehensive database of unique marketing and creative talent and innovative tactical resources in the industry, 2) flexible, scaleable web application technology (cloud) to support collaboration, dashboard reporting and tracking, 3) aggregation of services such as financial, legal, marketing and operational business process/systems, 4) professional assistance to help clients and members find the best talent for any solution, 5) a transparent quality monitoring system to evaluate all project participants (performance ratings for both virtual team member and client). The result is a technology-driven virtual agency model that changes the way the marketing and communications industry operates.

Embodiments of the present invention comprise six logical operational components. The Talent component provides support for the way highly creative thinkers work and interact. The Project component provides the technology for integrating with clients, including secure, multiple access levels to all members, clients and vendors. The Tools component provides collaboration tools across disciplines and geography. The Facilitation component provides support for engagements and projects. The Sales component provides the client engagements required to support the Talent Network. The result is a highly adaptive and efficient virtual team that is cost-effective across a wide range of marketing and communication applications and media platforms (social, digital, direct, experiential, broadcast, print, interactive, eCRM, etc.)

### BRIEF DESCRIPTION OF THE DRAWINGS

FIG. 1A is a system architecture diagram of an embodiment of the present invention.

FIG. 1B is a block diagram indicating functional elements in accordance with an embodiment of the present invention.

FIG. 2 is an exemplary user interface for creating a client engagement request.

FIG. 3 is an exemplary user interface for creating a virtual team member profile.

FIG. 4 is a flowchart indicating process steps in accordance with an embodiment of the present invention.

FIG. 5 is a system block diagram of an embodiment of the present invention.

### DETAILED DESCRIPTION

Embodiments of the present invention provide a system and method for assembling a virtual agency. One embodiment is an advertising agency. The client engagement is the central focus of this invention. Based on a client's needs and requirements, a virtual (ad hoc) team is assembled from the Talent Network to complete the contracted (assigned) task.

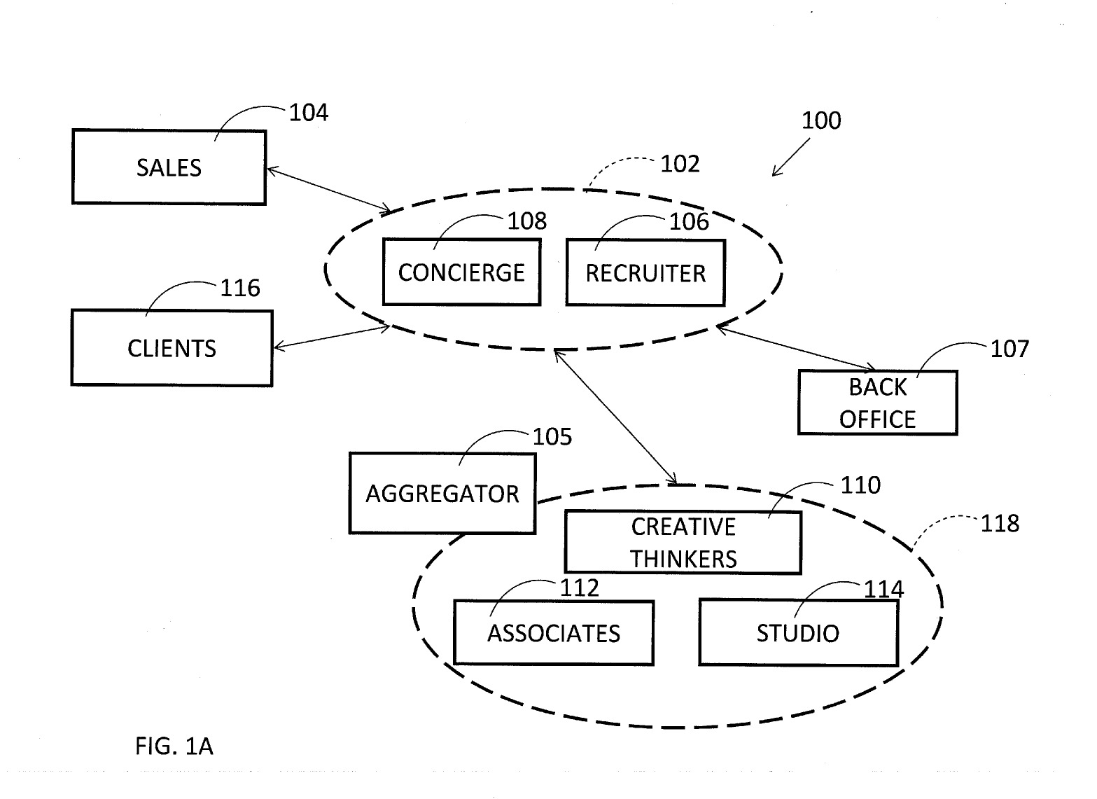

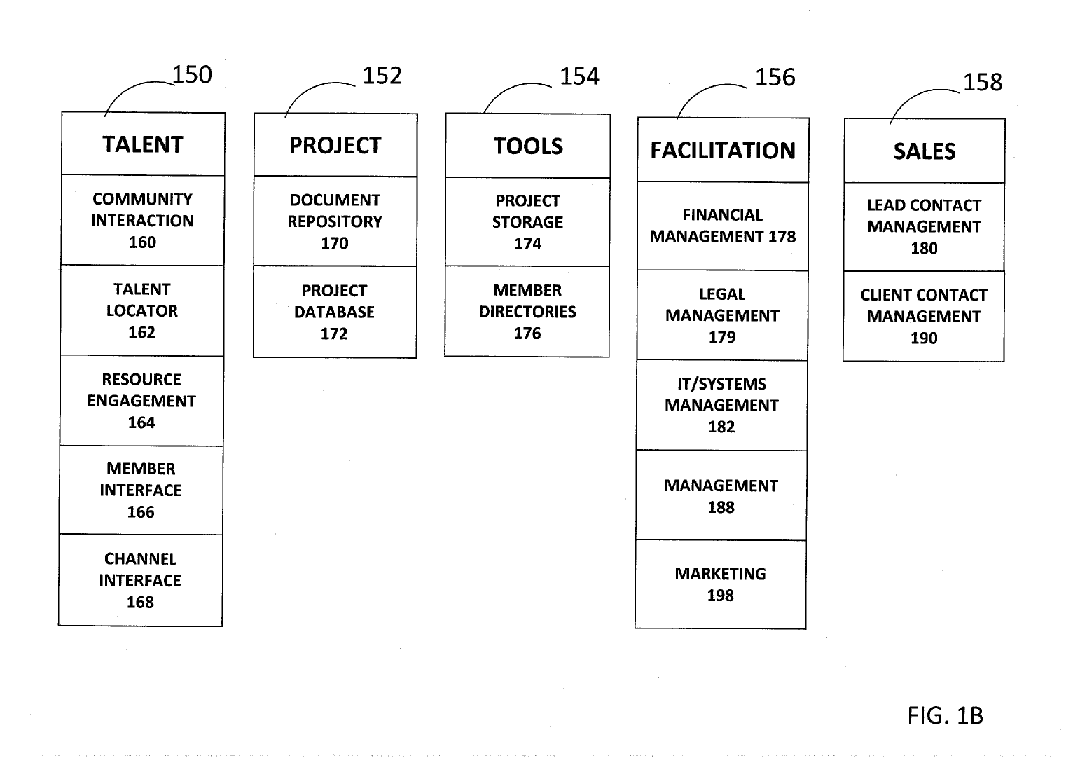

FIG. 1A is a system architecture diagram 100 of an embodiment of the present invention. The architecture is comprised of a frontline services unit 102 and a marketing and communications creative unit 118. Within the frontline services unit 102 is a concierge unit 108, and a recruiter unit 106. The concierge unit 108 ensures the most appropriate team members are assigned to a given project, initiates and monitors each engagement and also monitors client satisfaction with the engagement. The role of the concierge is central to the overall functioning of virtual teams and supporting technology. The concierge also monitors, tracks and manages (as necessary) day-to-day interaction with the Talent Network as engagement coordinator. As engagement coordinator, the concierge manages and reports on project, talent and operations dashboard status, provides answers to client and network members and arranges all project engagements with clients and new business. The recruiter unit 106 is responsible for assessing new virtual team members of the creative unit 118, and manages resource availability of current virtual team members. The role of the recruiter unit is also to ensure that the best available talent pool is in place to provide marketing and communications solutions to the client's business problem. In one embodiment, the recruiter unit 106 manages a performance rating system across the entire talent pool (of virtual team members) and clients. In another embodiment, the recruiter unit 106 manages relationships with other resources organizations (search firms, recruitment firms, etc.) to leverage their existing qualified talent pools. In another embodiment, the recruiter unit 106 builds a matrix of talent to support new capabilities service packages working with sales and executive management.

In another embodiment, the recruiter unit 106 works directly with the concierge unit (108) to provide specific individual talent (staff augmentation) to clients.

The marketing and communications creative unit 118 comprises aggregators 105, associates 112, creative thinkers 110, and studios 114. Within the marketing and communications creative unit each person, organization, or service firm must choose a core competency—the one area where they excel to ensure the highest level of talent performance is aligned to the talent service packages clients ultimately buy.

The creative thinkers 110 are independent strategic leaders accomplished and successful within their field across a broad range of marketing, communications and creative disciplines. Creative thinkers work with concierge 108, recruiters 106 and sales 104 to validate the feasibility of new client engagements. In one embodiment, creative thinkers collaborate (join) forming ad hoc teams to provide clients with strategic solutions to complex, multi- and single media channel consumer communication business problems. In another embodiment, creative thinkers may also act as their own independent mini-agency within the Talent Network. In another embodiment, the creative thinkers may act as a client, accessing the Talent Network to augment their own teams with specialized skill-sets or create customized ad hoc teams to address a unique project within one of their client accounts.

The associates 112 are freelance, perma-lance (permanent freelance) or contract individuals providing tactical specialties and/or core competencies required to execute a project and may include, but are not limited to, the following functions:
Copywriter
Art Director
Production Artist
Media Planner
Media Buyer
Account Planning
Video Director
Photographer
Web Designer
Branding Expert
Flash Designer
Reputation Management Expert
Social Networking Expert
Search Engine Optimization Expert
Campaign Analytics and Measurement Expert
Mobile Advertising Expert
Video Game Advertising Expert
Front-end/Back-end Developers
Online Lead Generation Expert
Ad Campaign Manager
Pay Per Click Advertising Expert
Outdoor Advertising Expert
Radio Advertising Expert
Account Management Expert
Project Management Expert

The aggregator unit 105 is identified from within either creative thinkers, concierge, associate or client units to manage the virtual project teams. The aggregator provides a vital role in working with the concierge and clients to validate specific resource request requirements, project specifications, and may be involved in the talent selection process and manages project processes. The role of the aggregator is central to an engagement's agreed upon project coordination, management and delivery upon completion of the engagement (staffing) process. The aggregator also manages individual project(s) scope, estimate, and project plan and resource utilization ensuring optimum availability of virtual team members. The role may also include overseeing project workloads and hours spent (as compared to scope) using Talent Network supporting technology. The service they provide is optional, since some clients may provide their own aggregation (project management, account management, etc.) to manage the project process. The aggregator (virtual or client-side team member) is trained in the virtual agency systems and methods and is certified to act as a project aggregator.

The Studio Unit 114 is comprised of, but not limited to, service firms providing resources for production specialties. These specialties may comprise photography, audio/video production, off-shore digital production, fulfillment, or 3^{rd} party software venders, for example.

The Sales unit 104 is responsible for accelerating the virtual outsourcing agency model growth by mining incremental opportunities within current clients, as well as cultivating new clients (engagements) within targeted categories. In one embodiment, the sales unit 104 provides an agency with a new business development function, framing opportunities with solutions that feature new and existing service packages (talent) across a variety of multi- and single media channels, or identifies new and/or unique capabilities/opportunities required to meet a client's needs. In another embodiment, the sales unit performs lead generation function: targets, qualifies, pursues, closes and transitions new business. The sales unit works closely with the concierge and recruiter to identify the mix of resources/services (new service packages, enhanced capabilities, new creative technologists (creative thinkers, network innovations, etc.) to be taken to market.

A client 116 may be comprised of a range of Talent Network users: other agencies, brand marketers, holding companies/portfolio agencies, recruiters, consulting agencies, creative thinkers, etc. . . . that have a need for marketing and communication skills and services for a particular scenario, such as a new product launch. The sale unit 104 and concierge unit 108 interact with clients 116 to complete an engagement request (system template). The client engagement request contains requested project deliverables including initial staffing request, timing, costs, and required specifications necessary to compile a virtual team. The request is managed by the concierge 108, who, working with the recruiter 106 and creative thinker 110 (optional) or aggregator 105 (optional), work together to validate the engagement requirements and determine the skill-set and experience level of talent to perform the necessary Talent Network search. Embodiments of the present invention assemble the virtual team that most closely matches the request of the client. Members of the marketing and communications creative unit 118 may also participate in this planning/definition phase of the engagement. Once the virtual team and engagement pricing is approved embodiments of the invention assembles individual project team(s), hands-off to an aggregator to “kick-off” the creative development/production processes and begins dashboard monitoring of progress.

A back office team 107 provides both tactical and strategic management for front-to-back office operational systems and processes. This may include, but is not limited to:

an information technology support team comprised of individuals tasked with ensuring uninterrupted access to the network and monitors web initiatives (i.e. public web site, intranet, web/email, instant messaging, teleconferencing, Skype, etc.). This IT unit also manages a technology team whose responsibility is to maintain the integrity of member directories, data collection and systems through software, web and multiple screen application development, social/community interactions and other methodologies;
a marketing team who, works with management to package and clearly communicates the virtual outsourcing agency brand positioning in the marketplace through targeted external and internal program/campaigns attracting and securing the best creative and communications talent in the industry;
a financial team manages all contractual agreement negotiations (client, strategic partners, talent, service firms, etc.) and monitors profitability of the company including cost control, cost of engagement, membership fees, service fees, among other success metrics;
a legal team manages all corporate contracts, policies, liability information, among other corporate responsibilities;
a management team that determines which specified service packages (and supporting talent) will be offered to current and potential clients, which may include, but are not limited to, digital marketing services, digit/technology automation services, internet/eCommerce platform services, advertising services, digital media services, direct/database services, etc. Service packages offerings are ultimately supported by the Talent Network, which is comprised of individuals with multiple core competencies, experience levels and specialized skills required within an identified service package.

Each service package is comprised of a number of service considerations (capabilities) that clients can purchase as a standardized single service package, a combined multiple service package, or can customize by picking and choosing individual capabilities across multiple service packages. For example, service considerations (capabilities across multiple standardized service packages) for a customized “digital marketing service package” may include, but are not limited to:

### Blogs/webinars/RSS

Digital campaign/advertising
Digital video
E-mail development and delivery
Mobile advertising
Online lead generation
Rich media production
Search engine marketing
Search engine optimization
Video game advertising

FIG. 1B is a block diagram indicating functional elements in accordance with an embodiment of the present invention. There is a talent functional element 150, project functional element 152, tools functional element 154, facilitation functional element 156 and a sales functional element 158.

The talent functional element 150 comprises a community interaction element 160. The community interaction module 160 is a key component of the success of the creative thinkers, enabling them to share knowledge, centralized resources and marketing tools with other partners and clients. The social capability provides for the interaction of systems of record and systems of engagement though ad hoc business search, data mining and business intelligence processes. Embodiments may provide information on key supporting processes such as: community management, social business transformation, and social business policy lifecycle. Furthermore, the social capability may also oversee the development of social business infrastructure and business architecture evolution in partnership with IT data security and compliance, human resources, and partnership oversight processes.

The talent locator module 162 allows the recruiter to search and/or browse for people based on expertise, location, client/category experience, industries, specializations, and roles. Each creative thinker has a profile page which includes contact information, resume/bio, case studies with expertise, experience and other information and/or links to all data they've created anywhere in the system (i.e., digital asset management structure). Each associate and studio services firms are featured in group profiles segmented by specialty and/or skill-set. Specialty pages provide the basic search data required to assemble a virtual team. The search capability may comprise simple, fast full text search (including attachments) with ability to use Boolean terms (and, or, not search logic), quoted phrases, and term weighting. Furthermore, the search capability may also include an advanced search on multiple fields, including members, clients, industry, specialty, location, author, type of data (including different media types), and also provide an ability to refine the search.

The engagement module 164 provides functionality that includes simple resource management and top-level project tracking for client generated projects. The module aggregates resource utilization and other useful information for tracking talent availability and project workloads. Furthermore, this module may also provide a tagging function for selected resources and produced assets within a client generated project.

The members interface module 166 provides a user with the functionality to instantly see and evaluate new Talent Network information generated from a variety of data sources that is relevant to that user's specific needs. In some embodiments, a user is able to establish preferences for how they want the information to be viewed.

The channel interface module 168 provides client-specific, strategic partner extranets that are useful in creating “sticky relationships” that are easy to track and manage. Embodiments may also provide usage tracking, which may include, but is not limited to, standard web log file analysis, channel usage, tracking of the most/least popular documents, and tracking of usage patterns for individual users, project teams, support teams and clients. In some embodiments, a user is able to establish preferences for how they want the information to be viewed.

The project functional element 152 comprises a document repository module 170 and a database module 172 that maintains the central component of Talent Network engagements, and provides storage to catalog all partner and client data.

The document repository 170 is accessible within various communities of interest where each partner user group will have access to shared information relevant to their ‘community’ and individual needs. An embodiment of the document repository is a creative folio that houses client and virtual team produced assets. The creative folio is an asset management function that ensures all project physical assets are centrally housed, maintained, and available throughout the life of the project. Project assets may be archived for future client projects and maintained through customized client extranets and social platforms. In addition, users can instantly archive creative development version rounds within workflow/approvals by editing it and enabling the “archived” flag.

In one embodiment, the document repository 170 provides workflow/approval functionality. Certain document types have workflow and approval processes associated with them, in which case, routing paths are identified in advance so the document gets to the right people. In addition, if anyone in the approval path misses his/her deadline for approval, the document can be re-routed to a delegate or backup and the appropriate parties can be notified by e-mail. Documents can be associated with each other arbitrarily, providing a flexible path to related data. These associations can be linear, relational or hierarchical. Before a user submits a document, he/she will choose which users/groups/personal groups/ad hoc groups will be able to view, edit, respond to, and/or delete the document. Users not included in a document's security definition cannot see the document. Users have the ability to specify an expiration date for a document, at which time it is moved to a different area. In addition, users can instantly archive a document by editing it and enabling the “Archived” flag. Data is backed up on a regular basis.

In another embodiment, the document repository 170 provides work in progress (WIP) functionality. Projects have distinct assets and supporting documentation that is shared during workflow/approval rounds and managed through service files and notations. This module may also be used to address new ideas requested, and, potentially for large scale projects to help minimize the complexity of addressing client comments.

Within the module index, files are created as easily searchable notes that can be saved in folders to provide reference to other files or information. In addition, index files can be added anywhere in the system based upon the level of team/project activity or requirements (ease of use).

Database 172 serves to streamline interactions, and aggregates content, tools and other useful information. In some embodiments, this module may provide a project dashboard for tracking and managing all projects related data.

The tools functional element 154 comprises project storage module 174 and member directories module 176. The project storage module 174 includes standardized system templates/tools, client/user-specific templates/tools and internal templates/tools.

In one embodiment, a user may access the project storage module for standardized system templates generated via basic project management capabilities including, phased tracking of project deliverables, schedule, budget, scope of work, approval/sign-offs, change management, issues/risk management, project debrief and/or other project issues.

In another embodiment, the project storage module 174 serves as a collection point for client/user-specific generated templates/documents across a broad range of engagements and project types including a variety of briefs (business, marketing, creative, etc.), checklists, conceptual matrices, staffing plans and other/or other required project templates/tools. Templates/tools are grouped logically for ease of search and shared use.

In addition, other types of internal engagement-specific templates/documents may also be stored here for sales, marketing and/or other self-promotion uses, including, but not limited to, templates, presentations, case studies, wireframes, blogging formats, creative/media assets, articles, press releases, or whitepapers, for example.

Member directories module 176 provides member information, which is centrally stored and available in a variety of directories that group data logically to ensure ease of search activities. Key directories may include, but are not limited to, data grouped by clients serviced, industry expertise, capability, talent core competency, service package users, for example.

External directories collect client and strategic partner information. For clients, this information may include: industry vertical, background, annual reports, products, services, credit worthiness, performance ratings, etc. For strategic partners (recruiters, executive search firms, etc.) this information may include: service type, industries serviced, unique talent offerings, rates/fees, performance ratings, etc.

Talent directories collect virtual team member information (aggregator, creative thinkers, associates and studio) that may include: rates, geography, areas of specialization, clients serviced, project overviews, performance ratings, etc.

Service package directories collect information that may include: package definition, service capabilities requirements, capability standards and talent competency requirements. Specialty pages provide basic search data required to match client needs, service package (capabilities) and talent (competencies).

The facilitation functional element 156 comprises a financial management module 178, a legal management module 179, an IT/systems module 182, a management module 188, and a marketing module 198.

The financial module 178 records all relevant corporate financial information by client partners and internal departments and reporting P&L, balance sheet, close the books, etc., and maintain this information in a secure, centrally located database. This module may also provide contract specific financial documentation and reporting tools including: procurement requirements, audit controls, service pricing, resource investments and billing instructions. Furthermore, this module may record new client and strategic partner financial information, and monitor financial position and credit worthiness. Embodiments may also include rate card development for engagements and project pricing as part of contract negotiations and governance.

The legal module 179 records all relevant negotiated contract agreements by clients, strategic partners, members and other corporate agreements and maintains this information in a secure, centrally located database. This module may provide corporate policies for managing liability across clients, strategic partners and members. Embodiments may also include providing regulatory requirement reviews (legal, trademark, copyright, gaming, sweepstakes, etc.) and/or specialized legal counsel requirements.

The IT module 182 provides the direct operating assistance (including software and application development) necessary to support Talent Network use/data management to all functional areas. The module records all information relevant for maintaining operating parameters (platform) for individual, team, partner and client use of IT systems, networks, architecture, security, data assurance, etc. This module may provide operating network and equipment needed to make the system function in accordance with the system size and operating standards. This module may also ensure capacity for operating applications development, and storing and securing the electronic information the company owns.

Embodiments may include software development where development and testing of software modules ensure that the system is operating correctly, and that all modules fit together as a whole including essential codes for running software, web applications, extranets and business applications (infrastructure). This functionality may also include technology updates and implementations.

Embodiments may also include application development that records the code required to make an application perform (monitoring, content, collaborating, communications, finance, etc.), taking into consideration hardware requirements and limitations. The functionality also includes hardware applications (multi/second screens) like web, mobile, tablet, PC consoles, laptops, etc.

The management module 188 records all relevant business information including business planning, sales planning, financial performance measurement, marketplace strategies, competitive analysis, etc. The module may provide other types of business information including servicing methodologies, formalized client/virtual agency report cards (performance reviews), action plans, planning updates, MARCO communication plans, etc. In addition, this module records all relevant service package development criteria and skill requirements ensuring consistency and scalability across a variety of transactions: standardized single service package, combined multiple service packages and customized (pick and choose capabilities) service packages and/or individual skill capabilities (staff augmentation) within a broad range of service packages. Furthermore, the management module 188 records new client, strategic partner and member approvals/referral recommendations, and may track this data against established integrity, ethical and high performance criteria providing the ratings framework against which all member groups and clients are evaluated.

The marketing module 198 are those who work with management, packages and clearly communicates the virtual outsourcing agency brand positioning in the marketplace through targeted programs/campaigns. It provides all relevant information for determining marketing mix (product, pricing, promotion and distribution), media communication channels (traditional, digital, social), strategic segmentation components and execution logistics for reaching targeted audiences and end-user segments. Marketing module 198 may also provide program/campaign planning calendars, success criteria (KPIs), optimization analytics and other tracking/measurement data to inform marketing plans. Embodiments may include a knowledge team that maintain the site in terms of content, training and education; an editing team comprised of individuals responsible for writing and approving content for placement on the web and social/community interactions. Embodiments may also include a recruitment acquisition support function adopting social and online communication campaign tactics to reach new talent segments necessary to build-out (maintain) and evolve service packages and underlying capabilities and core talent competencies, ensuring the best creative talent in the industry

The sales functional element 158 consists of a lead contact management module 180 and client contact management module 192 are both critical for identifying client engagements that ultimately lead to virtual team member projects.

The lead contact module 180 provides for tracking each engagement contact by various attributes, including, but not limited to, industry/category, activity, history, pending activity, and rating. In addition, the module may track demand generation leads from RFPs, RFIs and/or 3^{rd} party agency search consultants. This module may also provide other types of sales information: planning, forecasting, lead qualification, sales funnel management, pitch process, win/loss metrics, etc.

The client contact module 192 provides for tracking of incremental project opportunities within existing client engagements by monitoring activities/tasks which may include areas of engagement focus, project types, competitive environments, new innovations, etc. where the virtual agency provides shared information/insights. For example, new service package modifications, whitepapers, analytics, client success stories (case studies) and other relevant knowledge that may be customized for new business solution delivery. This module may provide other types of client contact planning information like account planning and forecasting, relationship management, opportunity development and/or new capability investment.

The underlying modules and features shown in FIG. 1B provide tools to personalize access to content and transactions, thereby providing easy access to tools to manage and deliver projects.

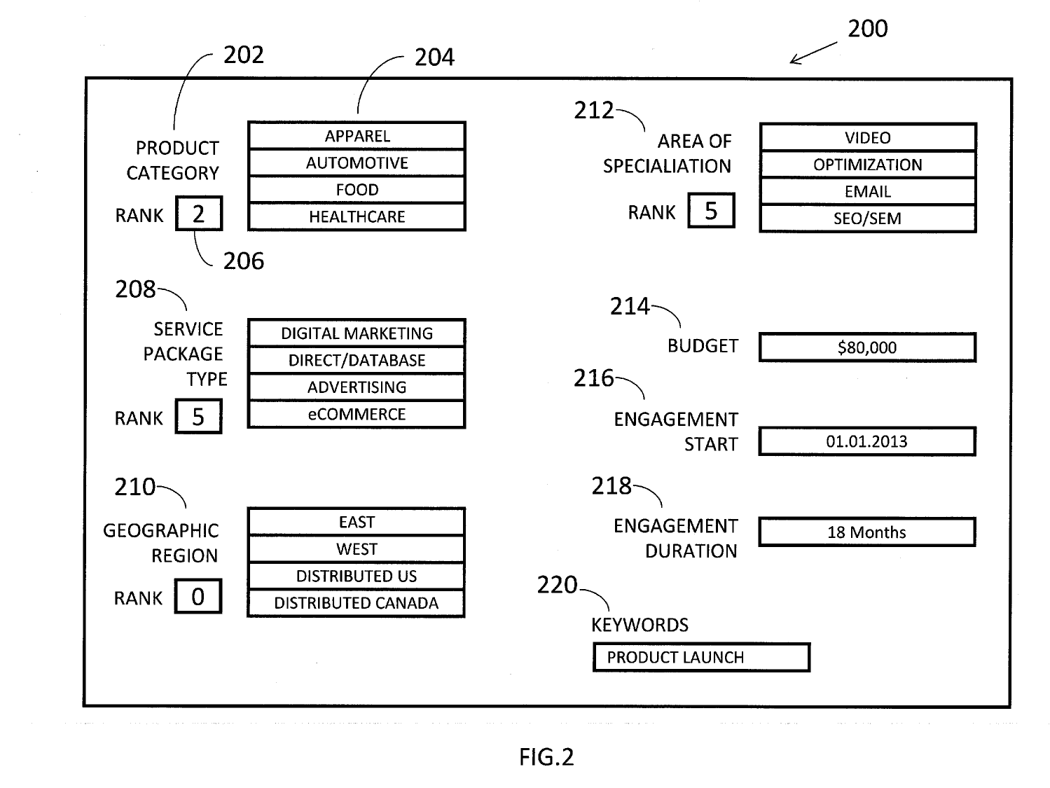

FIG. 2 is an exemplary user interface 200 for creating a client engagement request. The creation of a client engagement request is a collaborative activity working in concert with the frontline unit 102, marketing and communications creative unit 118 and aggregator unit 105. Note that for the sake of clarity, not all options are shown on user interface 200. However, it will be recognized that the other choices listed that are not shown may be implemented in a similar manner to those elements shown. On user interface 200, multiple elements are shown. Each element is a criterion used for selecting the most appropriate virtual team. Element 202 is product category (industry verticals). In this embodiment, a list box 204 displays a plurality of product categories. Note that for the sake of clarity, only four such categories are shown (apparel, automotive, food, healthcare). A practical embodiment may have many more such categories. This applies to all elements shown on user interface 200.

Element 208 is service package type. Element 210 is geographic region. Element 212 is area of specialization. Element 214 is the engagement budget. Element 216 is the desired engagement start date. Element 218 is the engagement duration. Element 220 allows entering of keywords for consideration when assembling the virtual team. For example, keywords for a particular area (e.g. product launch) or a particular skill (e.g. digital photo editing) may be entered in element 220 to receive consideration when searching through a pool of virtual team members.

A rank field 206 allows a client working with the frontline services unit 102, marketing and communications creative unit 118 and aggregator unit 105 to specify how important a particular element is when considering the formation of the virtual team. In one embodiment, the rank ranges from 0 (not important at all) to 5 (very important). For example, in the case of FIG. 2, an individual/team that has experience with search engine marketing has a rank set to five (very important), and the geographic consideration has a rank set to 0 (not important).

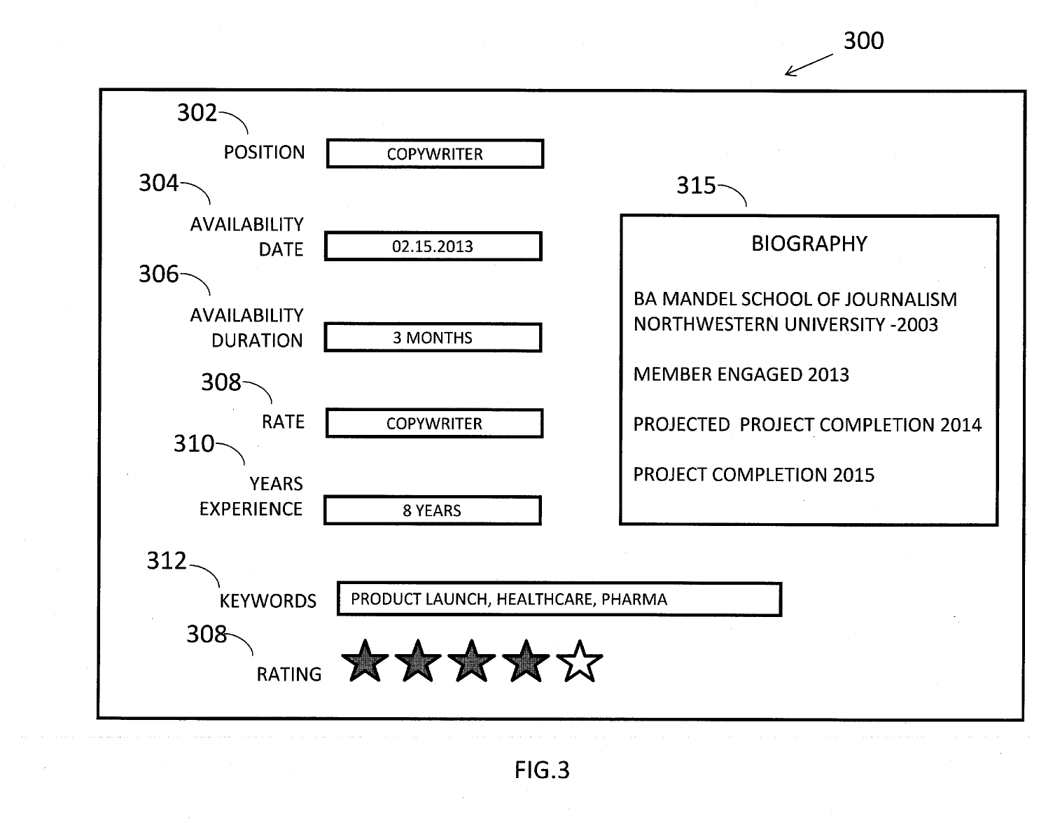

FIG. 3 is an exemplary user interface 300 for creating a virtual team member profile. Field 302 accepts a position (e.g. copywriter, photographer, etc. . . . ). Field 304 accepts an availability date. Field 306 accepts an available duration. Field 308 accepts a rate. Field 310 accepts years of experience for the virtual team member. Field 312 allows the optional use of keywords, which may include specific/unique skills capability, areas of specialization and/or expertise. Field 314 is a rating field, which may be based on client and virtual team feedback (e.g. formal satisfaction surveys) from previous assignments. Satisfaction surveys may include requests for feedback on usefulness of features and data, and online help, as well as suggestions regarding enhancement requests. In one embodiment, the feedback archives and status of requests is available to administrators, and an e-mail, mobile text or instant message is sent to users who request feedback. In another embodiment, the feedback is community based via web/social app where virtual teams and clients can comment on a specified project's interaction between service firms, virtual team members, vendors, client teams, etc. The feedback is monitored and evaluated through administrator access. Feedback follow-up and status are archived for future Talent Network reference (marketing and communications creative unit 118, aggregator unit 105, recruiter unit (106) and client unit 116).

Biography field 315 may optionally show relevant work and/or education experience. In one embodiment, a computer system systematically and periodically scans all profiles to identify possibly stale or out-of-date information. For example, in biography field 315, the string “member engaged 2013” may be recognized by a computer program. Another string “project #1 completion 2014” may also be recognized by a computer program. When the calendar year 2014 has passed, an e-mail notification may be generated and sent to the profile owner and/or system administrator to identify the stale information that would need to be updated. For example, in this case, the phrase “projected completion” may need to be removed if the user completed the degree. Alternatively, if the degree is still being pursued, the user may need to increment the year (e.g. so that the profile reads “projected project #5 completion 2015).

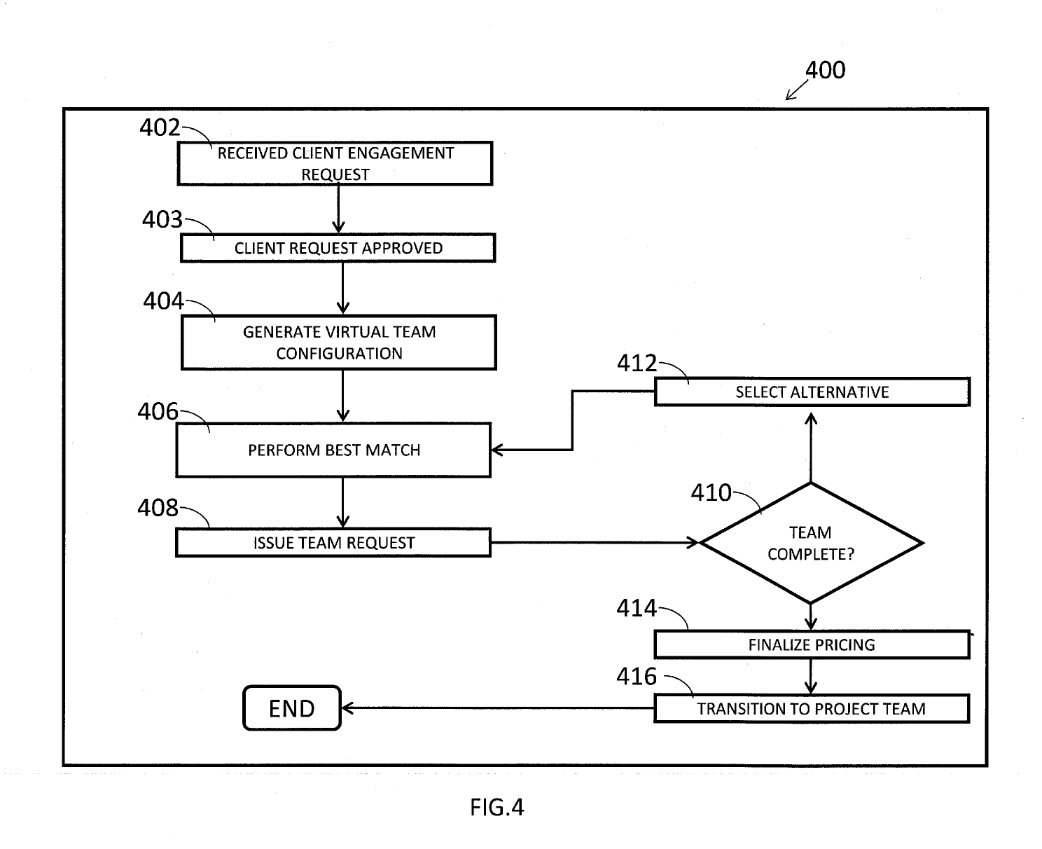

FIG. 4 is a flowchart 400 indicating talent assembly process steps in accordance with an embodiment of the present invention. In process step 402, a client engagement request is received. The client engagement request may specify various pertinent details of the engagement such as budget, duration, type of project, and other details, such as those shown in FIG. 2. In process step 403 the frontline services unit 102, creative thinkers unit 110 and aggregator unit 105 (optional) reviews feasibility of the engagement request and works with the recruiter unit 106 to ensures service package capabilities within Talent Network or recruits for new capabilities. In process step 404 a virtual team configuration is generated. This is a data structure that confirms the requirements for the virtual team. It may include information such as the mandatories, creative product specifications, number of team members, desired start date and others. It also specifies the positions (e.g. copywriter, photographer, etc.) needed for the team. Furthermore, important attributes, such as experience with a particular consumer segment (for example “Boomers”, “GenX”, etc.) or industry vertical, may also be included.

In process step 406 a best match is performed. This entails searching through multiple team member profiles to determine which team members would be the best fit for the virtual team configuration. In one embodiment, potential team members are eliminated until the list is culled to eligible team members. Then, from among the eligible team members, the best fit is selected. For example, the project start (216 of FIG. 2) and the project duration (218 of FIG. 2) maybe checked against the availability date (304 of FIG. 3) and the available duration (306 of FIG. 3) for each profile. Any team members that are not available are eliminated. The position field 302 is checked to ensure it matches the positions in the virtual team configuration. The other fields, such as years of experience, keywords, and ratings are used to refine the selection process. The rate information is used in estimating the project budget.

Once the best selection for each position in the virtual team configuration is derived, a team request is issued in process step 408. This may entail an automated e-mail, phone call, mobile text or instant message notifying the virtual team member of the new assignment. Each virtual team member may provide a response accepting or declining the assignment. In process step 410, an assessment is made to determine if the team is complete (all virtual team members accepted the assignment). In the event that some team members decline the assignment, alternative team members are selected in process step 412, and process steps 406-410 are repeated until all virtual team member assignments have been filled.

Once the best selection process is complete the frontline service unit 102 works with the financial and legal functions to negotiate/finalize pricing, contract requirements and all necessary engagement approvals/sign-offs executed and maintained by the financial function 178, are generated in process step 414.

In process step 416 the aggregator unit 105 is notified of an approved engagement. This completes (ends) the engagement process. A transition (hand-off) meeting is held by the concierge unit 108 with the aggregator unit 105 (team member specifically designated to coordinate an agreed upon project(s)). The aggregator unit 105 initiates the creative/production product development process. Working with the creative thinkers unit 110, the aggregator unit 105 prepares for project(s) kick-off and specific individual project(s) scope development or refinement.

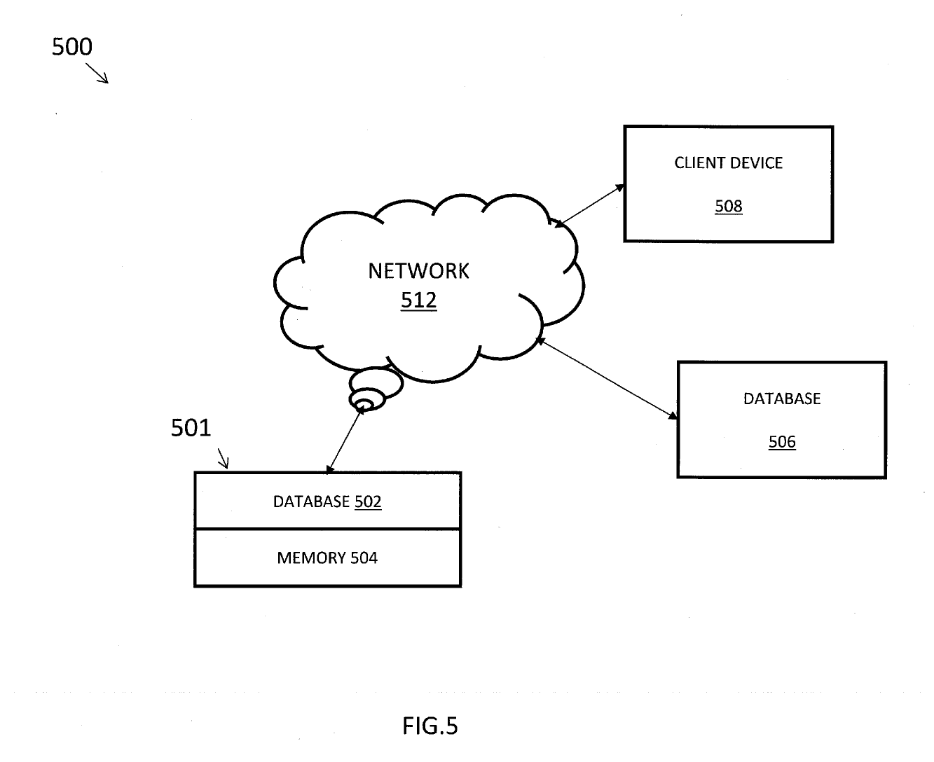

FIG. 5 is a block diagram of a system 500 in accordance with an embodiment of the present invention. Computer 501 comprises processor 502 and non-transitory memory 504. Memory 504 contains machine instructions. Processor 502 is configured to read those instructions from memory 504. When processor 502 executes those instructions, it performs steps shown in FIG. 4. Computer 501 may interact with a database 506 and client device 508 via a communications network 512. In one embodiment, communications network 512 may comprise the internet (distributed computing over a network and means the ability to run a program on many connected computers at the same time). The database 506 may contain records of the various personnel and entities, including the associates, clients, aggregator, creative thinkers, and studios. Client device 508 may comprise servers, personal computer (laptop/desktop), tablet computer, smart phone, or other mobile device supported by application, platform and infrastructure computing logic (cloud computing). The client device may interface with specific client, creative thinker, strategic partner, studio, etc. systems, and software/applications providing dashboard reporting of talent availability/status across the Talent Network. The client device may also comprise a keyboard, mouse, joystick, touchpad, wand, motion sensor, and other input means, for use in entering information into system 500. Through the client device 508, a user may perform various business and Talent Network tasks, such as assembling a virtual team, or entering profile data regarding a creative thinker, or monitoring availability dashboards, for example.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages (e.g. SQL), functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

I claim:

1. A method for creating a virtual agency comprising:
receiving a client engagement request;
generating a virtual team configuration based on the client engagement request;
identifying eligible team members from a team member database;
selecting a plurality of virtual team members from the eligible team members; and
issuing a team request to each of the plurality of virtual team members.

2. The method of claim 1, wherein issuing a team request comprises sending an e-mail, mobile text, or instant message to each virtual team member.

3. The method of claim 1, further comprising:
receiving a team response from the plurality of virtual team members;
issuing a team request to an alternate virtual team member upon receiving a team response with a negative indication from one of the plurality of virtual team members.

4. The method of claim 1, wherein the client engagement request comprises a product category, and identifying eligible team members from a member database comprises comparing the product category in the client engagement request with a product category associated with a profile of a virtual team member.

5. The method of claim 1, wherein the client engagement request comprises a service package type, and identifying eligible team members from a team member database comprises comparing the service package type in the client engagement request with a service package type associated with a profile of a virtual team member.

6. The method of claim 1, wherein the client engagement request comprises a geographic region, and identifying eligible team members from a team member database comprises comparing the geographic region in the client engagement request with a geographic region associated with a profile of a virtual team member.

7. The method of claim 1, wherein the client engagement request comprises an area of specialization, and identifying eligible team members from a team member database comprises comparing the area of specialization in the client engagement request with a specialization associated with a profile of a virtual team member.

8. The method of claim 1, wherein the client engagement request comprises an engagement start date, and identifying eligible team members from a team member database comprises comparing the engagement start date in the client engagement request with an availability date associated with a profile of a virtual team member.

9. The method of claim 1, wherein the client engagement request comprises an engagement duration, and identifying eligible team members from a team member database comprises comparing the engagement duration in the client engagement request with an available duration associated with a profile of a virtual team member.

10. The method of claim 1, wherein the client engagement request comprises one or more keywords, and identifying eligible team members from a team member database comprises comparing the one or more keywords in the client engagement request with one or more keywords associated with a profile of a virtual team member.

11. The method of claim 1, wherein the client engagement request comprises an experience preference (or position), and identifying eligible team members from a team member database comprises comparing the experience preference in the client engagement request with an experience level associated with a profile of a virtual team member.

12. The method of claim 1, wherein the client engagement request comprises a budget, further comprising:
computing an engagement cost for each virtual team member;
summing the engagement rate for each virtual team member to compute a total engagement cost;
comparing the total engagement cost to the budget from the client engagement request;
replacing a virtual team member with a lower cost alternate virtual team member if the total engagement cost exceeds the value of the budget.

13. A method for creating a virtual agency comprising:
receiving a client engagement request, wherein the client engagement request comprises a rank for a plurality of attributes;
generating a virtual team configuration based on the client engagement request;
identifying eligible team members from a team member database by generating a score based on the product of a match value and the corresponding rank;
selecting a plurality of virtual team members from the eligible team members based on the score;
issuing a team request to each of the plurality of virtual team members;
negotiating team (staffing plan) engagement pricing;
activating resources to implement an agreed upon subsequent single or multiple projects;
monitoring and reporting on project implementation progress and team member availability; and
rating team and client performance.

14. A system for creating a virtual agency comprising:
A computer, the computer comprising a processor and a non-transitory memory, wherein the processor is configured and disposed to access contents of said memory;
A database, wherein the processor is configured and disposed to access contents of said database, and wherein the database contains a plurality of virtual team member profiles;
wherein the memory contains machine instructions, that when executed by the processor, perform the steps of:
receiving a client engagement request;
generating a virtual team configuration based on the client engagement request;
identifying eligible team members from a team member database;
selecting a plurality of virtual team members from the eligible team members;
issuing a team request to each of the plurality of virtual team members; and
rating team and client performance.

15. The system of claim 14, wherein the memory contains machine instructions, that when executed by the processor, perform the steps of:
receiving a team response from the plurality of virtual team members;
issuing a team request to an alternate virtual team member upon receiving a team response with a negative indication from one of the plurality of virtual team members.

16. The system of claim 14, wherein the memory contains machine instructions, that when executed by the processor, perform the steps of:
retrieving a project start date from the client engagement request, and identifying eligible team members from a team member database, which comprises comparing the project start date in the client engagement request with an availability date associated with a profile of a virtual team member.

17. The system of claim 14, wherein the memory contains machine instructions, that when executed by the processor, perform the steps of:
retrieving a project duration from the client engagement request, and identifying eligible team members from a team member database, which comprises comparing the engagement duration in the client engagement request with an available duration associated with a profile of a virtual team member.

18. The system of claim 14, wherein the memory contains machine instructions, that when executed by the processor, perform the steps of:
retrieving one or more keywords from the client engagement request, and identifying eligible team members from a team member database, which comprises comparing the one or more keywords in the client engagement request with a one or more keywords associated with a profile of a virtual team member.

19. The system of claim 14, wherein the memory contains machine instructions, that when executed by the processor, perform the steps of: retrieving an experience preference, from the client engagement request, and identifying eligible team members from a team member database, which comprises comparing the experience preference in the client engagement request with an experience level associated with a profile of a virtual team member.

20. The system of claim 14, wherein the memory contains machine instructions, that when executed by the processor, perform the steps of:
retrieving a budget from the client engagement request;
computing a project cost for each virtual team member;
summing the project cost for each virtual team member to compute a total engagement cost;
comparing the total engagement cost to the budget from the client engagement request; and
replacing a virtual team member with a lower cost alternate virtual team member if the total engagement cost exceeds the value of the budget.

21. A method of monitoring and reporting talent availability status comprising:
receiving a talent engagement request, wherein applicable fields have been submitted;
generating a profile based on the client engagement request;
saving the profile to a database;
enabling a processor to access the database; and
generating a report, the report containing availability and engagement status of at least one client.

22. The method of claim 21 wherein the processor accessing the database involves searching using preset parameters.

23. The method of claim 21 further comprising:
using the report to generate a searchable database; and
sending a correspondence to the at least one client, the correspondence indicating options for available clients.

24. The method of claim 22 wherein the correspondence contains a response form for the client.
